(19) United States
(12) Patent Application Publication
(10) Pub. No.: US 2013/0187846 A1
(43) Pub. Date: Jul. 25, 2013

(54) BI-ORTHOGONAL PIXEL INTERPOLATION

(71) Applicants: Yingyong Qi, San Diego, CA (US); Min Li, San Diego, CA (US); Chia-Yuan Teng, San Diego, CA (US); Vasudev Bhaskaran, San Diego, CA (US)

(72) Inventors: Yingyong Qi, San Diego, CA (US); Min Li, San Diego, CA (US); Chia-Yuan Teng, San Diego, CA (US); Vasudev Bhaskaran, San Diego, CA (US)

(73) Assignee: QUALCOMM INCORPORATED, San Diego, CA (US)

(21) Appl. No.: 13/355,379

(22) Filed: Jan. 20, 2012

(51) Int. Cl. G09G 5/00

(52) U.S. Cl. 345/156

(57) ABSTRACT

The techniques described in this disclosure are directed to interpolating pixel values. In some examples, the techniques interpolate a pixel value for an interpolated center pixel based on pixel values of pixel that reside on diagonal lines that are orthogonal to one another. The techniques may determine first order derivative values and, in some examples, second order derivative values to determine which pixels to utilize to interpolate the pixel values for the interpolated center pixel. The techniques may similarly determine pixel values for non-center interpolated pixels using orthogonal vertical and horizontal lines.

### TECHNICAL FIELD

This disclosure is directed to pixel interpolation, and more particularly, to pixel interpolation for upscaling.

### BACKGROUND

Display devices may produce a range of image resolutions at or below the inherent maximum resolution. If the image data or information, however, defines values for fewer than all of the display pixels, the device may scale the image data upward to a larger spatial resolution. For example, a display device may produce additional pixels by interpolation to scale the image data to a larger format. As display devices become larger, image scaling becomes increasingly important. For mobile applications, even though users may desire larger displays, channel limitations tend to reduce the amount of image data that can be transmitted to a mobile device, resulting in smaller format images. Hence, image upscaling may be desirable for certain mobile applications.

### SUMMARY

In general, this disclosure is related to techniques to interpolate pixel values based on proximate pixels. The example techniques may determine first order derivative values based on neighboring pixels that reside along orthogonal diagonal lines relative to the interpolated pixel. In some instances, the example techniques may also determine second order derivative values based on pixels that reside along lines parallel to the orthogonal lines that are used to determine the first order derivative values. Based on the first and second order derivative values, a display processor may determine which pixels to utilize to interpolate the pixel values of the interpolated pixel.

The techniques of this disclosure may not need to determine first and second order derivative values in every example. In some instances, the techniques may determine the first order derivative values, which may be sufficient for the display processor to determine which pixels to utilize to interpolate the pixel values of the interpolated pixel. In these examples, the techniques may not determine second order derivative values.

In one example, the disclosure describes a method that includes determining a first value based on pixel values of pixels that neighbor an interpolated center pixel of a display and that reside along a first diagonal line. In the method, both x- and y-coordinates for the pixels that reside along the first diagonal line are different from one another. The method also includes determining a second value based on pixel values of pixels that neighbor the interpolated center pixel of the display that reside along a second line that is orthogonal to the first line. In the method, both x- and y-coordinates for the pixels that reside along the second line are different from one another. The method further includes comparing the first value and the second value to a threshold value, and when at least one of the first value and the second value is greater than the threshold value, performing an interpolation based at least on one of pixel values of the pixels that reside along the first diagonal line and pixel values of the pixels that reside along the second diagonal line to interpolate a pixel value for the interpolated center pixel of the display.

In another example, the disclosure describes an apparatus that includes a display that includes an interpolated center pixel and a processing unit. The processing unit is operable to determine a first value based on pixel values of pixels that neighbor an interpolated center pixel of the display and that reside along a first diagonal line. In this example, both x- and y-coordinates for the pixels that reside along the first diagonal line are different from one another. The processing unit is also operable to determine a second value based on pixel values of pixels that neighbor the interpolated center pixel of the display that reside along a second line that is orthogonal to the first line. In this example, both x- and y-coordinates for the pixels that reside along the second line are different from one another. The processing unit is further operable to compare the first value and the second value to a threshold value, and when at least one of the first value and the second value is greater than the threshold value, perform an interpolation based at least on one of pixel values of the pixels that reside along the first diagonal line and pixel values of the pixels that reside along the second diagonal line to interpolate a pixel value for the interpolated center pixel of the display.

In another example, the disclosure describes a computer-readable storage medium comprising instructions. The instructions cause one or more processing units to determine a first value based on pixel values of pixels that neighbor an interpolated center pixel of a display and that reside along a first diagonal line. In this example, both x- and y-coordinates for the pixels that reside along the first diagonal line are different from one another. The instructions also cause the one or more processing units to determine a second value based on pixel values of pixels that neighbor the interpolated center pixel of the display that reside along a second line that is orthogonal to the first line. In this example, both x- and y-coordinates for the pixels that reside along the second line are different from one another. The instructions further cause the one or more processing units to compare the first value and the second value to a threshold value, and when at least one of the first value and the second value is greater than the threshold value, perform an interpolation based at least on one of pixel values of the pixels that reside along the first diagonal line and pixel values of the pixels that reside along the second diagonal line to interpolate a pixel value for the interpolated center pixel of the display.

In another example, the disclosure describes an apparatus that includes means for determining a first value based on pixel values of pixels that neighbor an interpolated center pixel of a display and that reside along a first diagonal line. In this example, both x- and y-coordinates for the pixels that reside along the first diagonal line are different from one another. The apparatus also includes means for determining a second value based on pixel values of pixels that neighbor the interpolated center pixel of the display that reside along a second line that is orthogonal to the first line. In this example, both x- and y-coordinates for the pixels that reside along the second line are different from one another. The apparatus also includes means for comparing the first value and the second value to a threshold value, and when at least one of the first value and the second value is greater than the threshold value, means for performing an interpolation based at least on one of pixel values of the pixels that reside along the first diagonal line and pixel values of the pixels that reside along the second diagonal line to interpolate a pixel value for the interpolated center pixel of the display.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example of a device that may be operable to implement one or more aspects of this disclosure.

FIG. 2 is a graphical diagram illustrating an example of pixels located on a display and pixels of an image that are used to interpolate pixel values for an interpolated pixel.

FIG. 3 is a flowchart illustrating example techniques in accordance with one or more examples described in this disclosure.

FIG. 4 is a block illustrating another example of a device that may be operable to implement one or more aspects of this disclosure.

### DETAILED DESCRIPTION

The techniques of this disclosure are directed to interpolating a pixel, which may be usable for upscaling an image. For example, an image includes a plurality of pixels, each pixel having one or more pixel values. In some examples, the number of pixels defined by data representing the image may be less than the number of pixels on a display. In other words, the spatial resolution of the image may be less than the spatial resolution of the display. To increase the resolution of the image (e.g., upscale the image), a processing unit, such as a display processor as one example, interpolates pixel values for an interpolated pixel based on the pixels of the image.

The term “interpolated pixel” refers to a pixel that is present on the display, but not part of the pixels of the image. Therefore, the interpolated pixel is a pixel whose pixel values have to be determined based on pixel values for pixels within the image. The term “pixel values” may refer to, e.g., red, green and blue (RGB), or the like. In some cases, the pixel values also may be defined by various attributes of the pixels. There may be various pixels of the image that can be used to determine the pixel values for the interpolated pixels. The techniques of this disclosure are directed to selecting which pixels to use to interpolate the pixel values of the interpolated pixel. The techniques of this disclosure also describe which type of interpolation technique to employ. However, aspects of this disclosure are not so limited, and any interpolation technique may be utilized.

Selecting appropriate pixels of the image to interpolate pixel values of the interpolated pixel may increase the quality of the displayed image. For example, with poor interpolation, there may be jags along portions of the displayed image where there is substantial change in image contrast. As one example, jags occur when an interpolated pixel resides between a pixel with dark color and a pixel with light color, although other examples of substantial change in image contrast are contemplated by the techniques of this disclosure. These jags appear as a substantial jump in image contrast, rather than a smooth transition in the image contrast. For example, these jags may appear as stair-steps in the displayed image.

The appearance of jags may worsen as displays become larger in size. For example, displays of a cellular telephone may be small enough that jags are not highly noticeable. However, displays of tablet computing devices are generally much larger than those of cellular telephones. For such tablet computing devices, the appearance of jags may negatively impact the viewing experience.

To provide crisper interpolated images with minimal jags, this disclosure describes a two-pass technique for determining the pixel values for an interpolated pixel. For example, to determine the pixel values for an interpolated pixel, a display processor may divide the pixels of an image into blocks of pixels. In some examples, it may be possible for one block of pixels to be the entirety of the image. However, to ensure that there is sufficient memory for interpolation, one block of pixels may be a subset of the entirety of the image.

In the first pass of the two-pass technique, the display processor may determine the pixel values for the interpolated pixel that will reside in the center of the blocks of pixels. In the second pass, the display processor may determine the pixel values for the other interpolated pixels. As described in more detail, in the first pass, the display processor may determine the pixel values of the interpolated center pixel based on pixels located on orthogonal diagonal lines relative to one another. Then, in the second pass, the display processor may determine the pixel values for the other interpolated pixels based on the interpolated center pixel and pixels located on orthogonal vertical and horizontal lines.

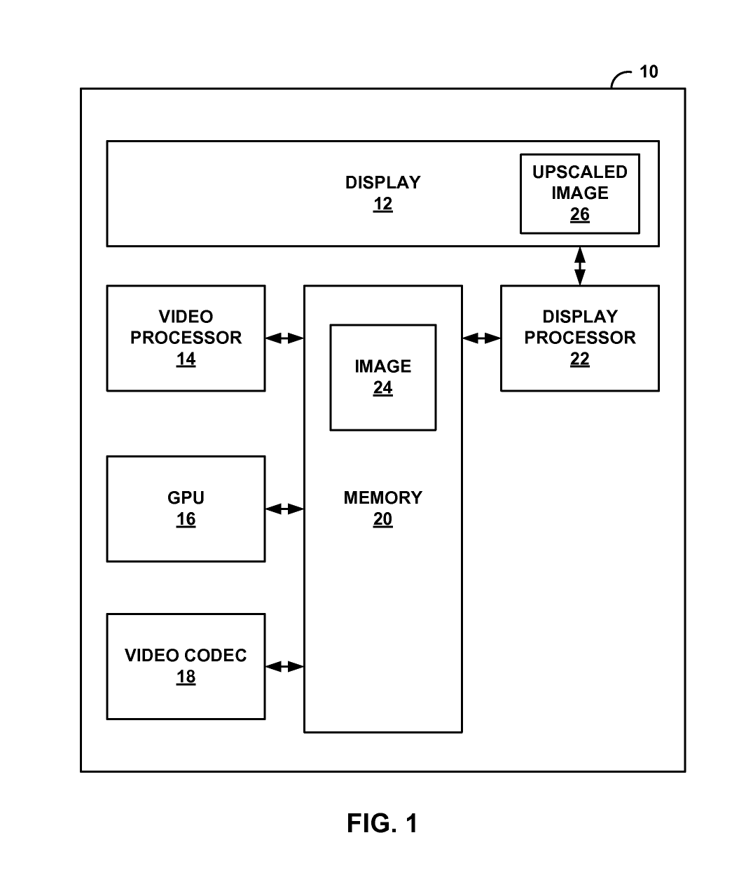

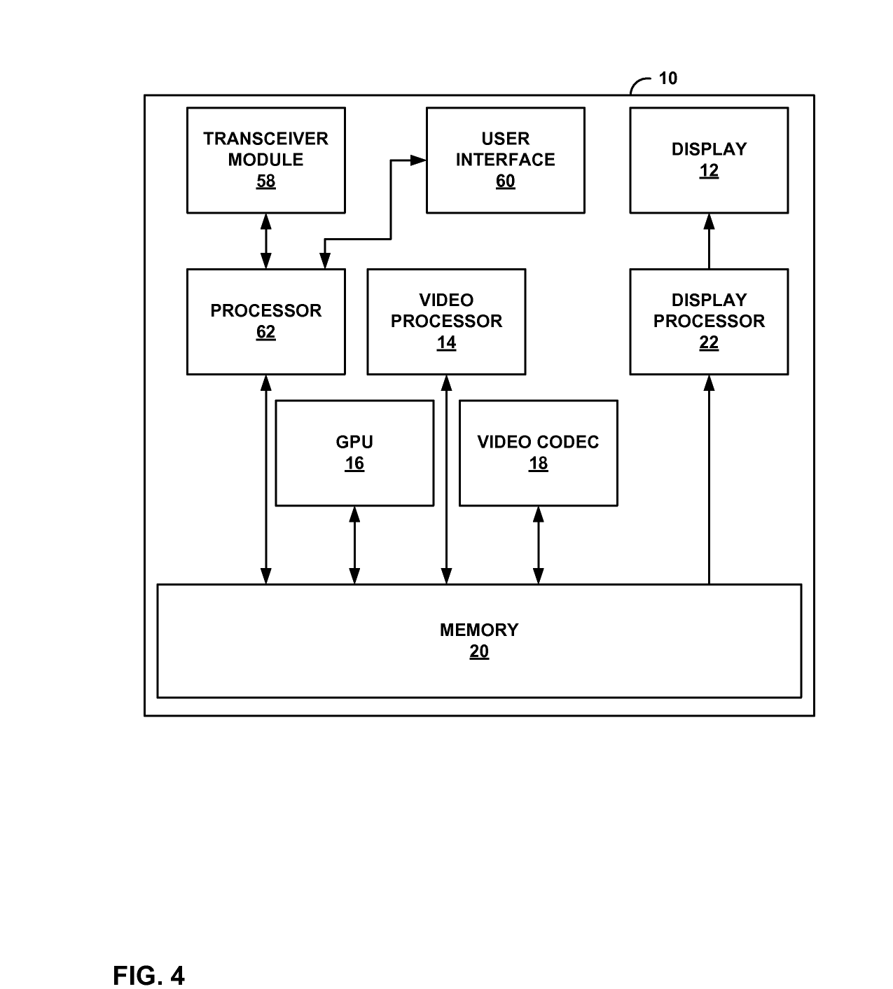

FIG. 1 is a block diagram illustrating an example of a device that may be operable to implement one or more aspects of this disclosure. For example, FIG. 1 illustrates device 10. Examples of device 10 include, but are not limited to, video devices such as media players, set-top boxes, wireless handsets such as mobile telephones, personal digital assistants (PDAs), desktop computers, laptop computers, gaming consoles, video conferencing units, tablet computing devices, and the like. As illustrated, device 10 may include display 12, video processor 14, graphics processing unit (GPU) 16, video encoder/decoder (coded) 18, memory 20, and display processor 22. Device 10 may include components in addition to those illustrated in FIG. 1. For example, FIG. 4 illustrates an example of device 10 that includes more components than those illustrated in FIG. 1.

Examples of video processor 14, GPU 16, video codec 18, and display processor 22 include, but are not limited, to a digital signal processor (DSP), a general purpose microprocessor, an application specific integrated circuit (ASIC), a field programmable logic array (FPGA), or other equivalent integrated or discrete logic circuitry. Furthermore, although video processor 14, GPU 16, video encoder-decoder (codec) 18, and display processor 22 are illustrated as separate components, aspects of this disclosure are not so limited. In alternate examples, one or more of video processor 14, GPU 16, video codec 18, and display processor 20 may be part of a common integrated circuit. For purposes of illustration and ease of description, video processor 14, GPU 16, video codec 18, and display processor 20 are illustrated as separate components.

Also, this disclosure describes display processor 22 as implementing the example techniques. In alternate examples, any one of the processing units of device 10 may implement the techniques described in this disclosure. For example, video processor 14, GPU 16, video codec 18, display processor 22, or a central processing unit (CPU) of device 10 may implement the techniques described in this disclosure. To indicate this, in some examples, this disclosure describes a processing unit as performing the techniques described in this disclosure. Examples of such a processing unit include video processor 14, GPU 16, video codec 18, display processor 22, or the CPU of device 10.

Video processor 14, GPU 16, and/or video codec 18 may output image data to memory 20. For example, memory 20 may store image 24 which is an image generated from any one of video processor 14, GPU 16, or video codec 18. It may be possible for other components not shown in FIG. 1 to generate image 24 and store image 24 in memory 20, and video processor 14, GPU 16, and video codec 18 are described for purposes of illustration. Display processor 22 may retrieve image 24 from memory 20 and present the image on display 12.

Display 12 may comprise a liquid crystal display (LCD), an organic light emitting diode display (OLED), a cathode ray tube (CRT) display, a plasma display, or another type of display device. Examples of memory 20 include, but are not limited to, a random access memory (RAM), a read only memory (ROM), an electrically erasable programmable read-only memory (EEPROM), CD-ROM or other optical disk storage, magnetic disk storage, or other magnetic storage devices, flash memory, or any other medium that can be used to store desired program code in the form of instructions or data structures and that can be accessed by a central processing unit (CPU) of device 10, display processor 14, GPU 16, video codec 18, and display processor 22. In some example memory 20 may comprise one or more computer-readable storage media, such as a computer-readable storage device. For instance, in some example implementations, memory 20 may include instructions that cause display processor 22 to perform the functions ascribed to display processor 22 in this disclosure.

Memory 20 may, in some examples, be considered as a non-transitory storage medium. The term “non-transitory” may indicate that the storage medium is not embodied in a carrier wave or a propagated signal. However, the term “non-transitory” should not be interpreted to mean that memory 20 is non-movable. As one example, memory 20 may be removed from device 10, and moved to another device. As another example, a storage device, substantially similar to memory 20, may be inserted into device 10. In certain examples, a non-transitory storage medium may store data that can, over time, change (e.g., in RAM).

As one example, a user may desire to view video content on display 12. Video processor 14 may process the video content and store the video content as a series of images 24 (referred to as frames or pictures) in memory 20. Display processor 22 may retrieve each of images 24 from memory 20 and display them via display 12 at a particular frame rate so that the user experiences a smooth playing of the video.

As another example, a user may desire to play a video game on device 10. In this example, GPU 16 may generate graphics content for the video game in the form of images 24 that GPU 16 stores in memory 22. Display processor 22 may retrieve the video game images 24 from memory 20 and display them via display 12. Applications other than the video game may also generate graphics content that display processor 22 may retrieve and display on display 12.

As yet another example, video codec 18 may decode received video content. Similar to video processor 14, the decoded video content may be a series of images 24. Video codec 18 may store these series of images in memory 18. Similar to video processor 14, display processor 22 may retrieve the images from memory 20 and display them via display 12.

Prior to displaying images 24 on display 12, display processor 22 may perform image upscaling. Display processor 22 may then display this upscaled image. For example, FIG. 1 illustrates display 12 as displaying upscaled image 26. Upscaled image 26 is the resulting image from the upscaling of image 24.

Image upscaling refers to the inclusion of additional pixels in the image to increase the resolution of the image. For example, the number of pixels in image 24 stored in memory 20 by video processor 14, GPU 16, or video codec 18 may be less than the number of pixels of display 12. In other words, the resolution of image 24 stored in memory 20 may be less than the resolution of display 12. Display processor 22 may be operable to increase the resolution of the stored image 24 to be substantially equal to the resolution of display 12.

Although FIG. 1 illustrates display processor 22 receiving image 24 from memory 20, e.g., system memory, aspects of this disclosure are not so limited. It may be possible for display processor 22 to receive image 24 directly from any one of video processor 14, GPU 16, and video codec 18, e.g., by direct memory transfer, rather than through system memory 20. However, for purposes of brevity, the techniques are described with respect to display processor 22 receiving image 24 from memory 20.

One way in which display processor 22 increases the resolution of image 24 is referred to as interpolation. Interpolation refers to utilizing pixel values for pixels within the image to determine pixel values for a pixel on the display that does not exist in the image. For example, assume that display 12 includes 100×100 pixels and image 24 includes 25×25 pixels. In this case, if image 24 were displayed on the entirety of display 12 (e.g., the corner pixels of image 24 are displayed at the corner pixels of display 12), then there would be no pixel values for the pixels of display 12 that are in between the pixels of image 24 because the resolution of image 24 is less than the resolution of display 12. Interpolation is used to determine the pixel values for the pixels of display 12 that do not have a corresponding pixel in the image. In this way, there will be no blank pixels (e.g., pixel of display 12 without pixel values) when display processor 22 displays upscaled image 26 on display 12.

In this disclosure, the pixel that is present on display 12, but not part of image 24 is referred to as an “interpolated pixel.” Because the interpolated pixel does not have a corresponding pixel in the image, the pixel values for the interpolated pixel may need to be interpolated from pixel values for pixels within the image. The term “pixel values” refers to values of the attributes of the pixels such as, but not limited to, color values, opaqueness values, and other values that define the pixel. Accordingly, upscaled image 26 includes pixel values for interpolated pixels that are interpolated from pixels of image 24. Upscaled image 26 may also be referred to as an interpolated image to indicate that one or more of the pixel values for the pixels in upscaled image 26 are interpolated from pixels within image 24.

There may be various pixels that display processor 22 may utilize to interpolate pixel values for the interpolated pixel. For example, some techniques may rely on using pixels that reside on a line that is vertical relative to the interpolated pixel and pixels that reside on a line that is horizontal relative to the interpolated pixel. A line that is vertical relative to the interpolated pixel refers to a line that includes pixels of the image that have different y-coordinates and the same x-coordinate on the display. A line that is horizontal relative to the interpolated pixel refers to a line that includes pixels of the image that have different x-coordinates and the same y-coordinate on the display. These other techniques would interpolate pixel values for all of the interpolated pixels based on pixels that reside along these horizontal and vertical lines.

However, these other techniques resulted in jaggy edges in the resulting interpolated image. Jaggy edges may occur on an edge where there is substantial change in contrast. For example, an edge may be considered as a line, where the pixel values, such as the color values, on one side of the line are substantially different than the pixel values on the other side of the line. These jaggy edges appear as stair-steps along the edge where there is substantial change in contrast. In other words, the jaggy edges appear as if there is not a smooth transition between pixels with substantially different contrasts. These jaggy edges may negatively impact the quality of the displayed image.

The techniques described in this disclosure provide for example ways in which display processor 22 may select which pixels to utilize to interpolate the pixel values for an interpolated pixel. Once display processor 22 selects which pixels to utilize to interpolate the pixel values for the interpolate pixel, display processor 22 may determine which type of interpolation to perform based on a threshold value, as described in more detail. For example, display processor 22 may perform linear interpolation or weighted interpolation based on a comparison with the threshold value. However, aspects of this disclosure are not so limited, and display processor 22 may select interpolation types other than linear and weighted interpolation regardless of the comparison with the threshold value.

The techniques of this disclosure may be applicable for dyadic upscaling, although aspects of this disclosure should not be considered so limiting. Dyadic upscaling refers to interpolating pixel values for interpolated pixels to increase the resolution of the image by a factor of 2 (e.g., 2×, 4×, 8×, 16×, etc.). As an alternate example, the techniques of this disclosure may be used for dyadic upscaling followed by re-sampling from the dyadic upscaled image for multi-phase scaling. For example, display processor 22 may re-sample and perform multi-phase scaling on upscaled image 26, and present the resulting image on display 12. In this example, display processor 22 may use any re-sampling and multi-phase scaling technique.

Moreover, the techniques of this disclosure are described with respect to interpolating pixel values with the understanding that display processor 22 may utilize the interpolation scheme described in this disclosure for each of the pixel values. As one example, the color values for a pixel of image 24 may be RGB color values, where there is a value for the red component, a value for the green component, and a value for the blue component for each pixel in image 24. In this case, display processor 22 may utilize the red component values for the selected pixels in image 24, which are used for interpolation, to generate the red component value for the interpolated pixel. Similarly, display processor 22 may utilize the green component values for the selected pixels in image 24, which are used for interpolation, to generate the green component values for the interpolated pixel, and the same may apply for the blue component values.

Accordingly, when this disclosure describes interpolation of pixel values, as one example, display processor 22 may interpolate the red-green-blue values for the interpolated pixel by interpolating the red component value of the interpolated pixel from the red component values of each of the selected pixels, the green component value of the interpolated pixel from the green component values of each of the selected pixels, and the blue component value for the interpolated pixel from the blue component values of each of the selected pixels. Display processor 22 may perform the interpolation for each of the red, green, and blue component values in parallel (e.g., at the same time) or sequentially (e.g., one after the other). For purposes of brevity, the techniques are described generally as display processor 22 interpolating pixel values.

To select which pixels to utilize for interpolation, display processor 22 may divide image 24 into a plurality of blocks of pixels and implement a two-pass technique. In the first pass of the two-pass technique, display processor 22 may determine the pixel values for the interpolated pixel that will reside in the center of each block of pixels. In the second pass, display processor 22 may determine the pixel values for the other interpolated pixels. As described in more detail, in the first pass, display processor 22 may determine the pixel values of the interpolated center pixel based on pixels located on orthogonal diagonal lines. Then, in the second pass, display processor 22 may determine the pixel values for the other interpolated pixels based on the interpolated center pixel and pixels located on orthogonal vertical and horizontal lines.

As one non-limiting illustrative example, display processor 22 may divide the pixels of image 24 into 4×4 blocks of pixels. It may be possible that there is only one block of pixels, where this block of pixels is the entirety of image 24. However, for processing purposes and the availability of local memory on display processor 22, the size of the blocks of pixels of image 24 may be smaller than the entirety of image 24.

In this illustrative example where display processor 22 has divided the pixels of images 24 into 4×4 blocks of pixels, assume that a 4×4 block of pixels includes pixels located at (1, 1) to (4, 4). In this example, the center of this block is (2.5, 2.5). It should be understood that in image 24 there is no pixel located at (2.5, 2.5). However, when image 24 is interpolated (e.g., upscaled), upscaled image 26 will include a pixel that corresponds to the (2.5, 2.5) location within image 24. For instance, there is a pixel on display 12 that corresponds to the location (2.5, 2.5) in image 24. In the first pass of the two-pass technique, display processor 22 may determine the pixel value for the interpolated pixel that will reside in upscaled image 26 at the location in display 12 that corresponds to (2.5, 2.5) in image 24.

The other interpolated pixels are pixels that are located at (1, 1.5), (1, 2.5), and (1, 3.5), (1.5, 1), (1.5, 1.5), (1, 5, 2), (1.5, 2.5), (1.5, 3), and (1.5, 3.5), and so forth in the 4×4 block of pixels. Display processor 22 may determine the pixel values for these other interpolated pixels in the second pass. In some examples, display processor 22 may interpolate the pixel values for all of the interpolated center pixels in the first pass. After display processor 22 interpolates these pixel values for the interpolated center pixels, display processor 22 may interpolate pixel values for the remaining interpolated pixels in the second pass.

To determine the pixel values for the interpolated center pixel in the first pass, display processor 22 may determine first order derivatives of pixel values of two immediately neighboring pixels that reside on orthogonal diagonal lines relative to the center of the block. In the example above, the center is located at (2.5, 2.5), and a first diagonal line includes immediately neighboring pixels located at (2, 2) and (3, 3), and a second diagonal line includes immediately neighboring pixels located at (2, 3) and (, 2). In this example, the first diagonal line and the second diagonal line intersect one another at (2.5, 2.5), which is the coordinate for the center of the block. Also, the angle between the first and second diagonal lines is approximately 90° (i.e., the first and second diagonal lines are orthogonal to one another).

In general, as used in this disclosure a diagonal line refers to a line of pixels. The pixels that reside along a diagonal line include x- and y-coordinates that are different than the x- and y-coordinates of the other pixels that reside on the diagonal line. For instance, in the above example, the first diagonal line includes pixels located at (2, 2) and (3, 3). In this example, both the x- and the y-coordinates for these pixels that reside along the first diagonal line are different relative to one another. Similarly, the second diagonal line includes pixels located at (2, 3) and (3, 2). In this example, both the x- and the y-coordinates for these pixels that reside along the second diagonal line are different relative to one another.

To determine the first order derivative of the first diagonal, display processor 22 may subtract the pixel values for the pixels in the first diagonal, and determine the absolute value of the resulting value. For example, the display processor may subtract the pixel values of the pixel located at (2, 2) from the pixel values of the pixel located at (3, 3), and determine the absolute value. This absolute value will be referred to as D1 (e.g., the first order derivative of the pixel values located at (2, 2) and (3, 3) which form the first diagonal). To determine the first order derivative of the second diagonal, the display processor may subtract the pixel values for the pixels in the second diagonal, and determine the absolute value of the resulting value. For example, the display processor may subtract the pixel values of the pixel located (2, 3) from the pixel values of the pixel located at (3, 2), and determine the absolute value. This absolute value will be referred to as D2 (e.g., the first order derivative of the pixel values located at (2, 3) and (3, 2) which form the second diagonal).

In the first pass, display processor 22 may compare each of the absolute values (e.g., Dl and D2) to a threshold value to determine whether D1 and D2 are less than the threshold. For instance, display processor 22 may determine whether both D1<Th and D2<Th, where Th is the threshold value. The threshold value may be a user defined or preprogrammed value, and may be based on design choice. For example, a larger threshold value may result in faster processing time, but may result in more jags in upscaled image 26 as compared to a smaller threshold value, where the processing time may be greater, but the jags may be further minimized.

If this criterion is not met (e.g., at least one of D1 and D2 is not less then the threshold), the display processor may select the smaller of D1 and D2 and perform interpolation on the pixel values for the pixels that make up the smaller of D1 and D2. In this example, the interpolation may be linear interpolation. For instance, in this example, display processor 22 may select pixels located on the diagonal line that are used to determine the lesser of the D1 and D2 values. In this example, display processor 22 may then perform linear interpolation using the pixel values of the selected pixels. It should be noted that although this disclosure describes display processor 22 as performing linear interpolation in this situation, aspects of this disclosure are not so limited, and display processor 22 may perform a different type of interpolation.

In some examples, it may be possible that D1 equals D2. For these cases, display processor 22 may be configured to perform linear interpolation (as one example) using the pixel values for the pixels located on one of the diagonals used to determine D1 and D2. For instance, display processor 22 may be configured to always select the pixels located on the diagonal line used to determine the D1 value for interpolation, or always select the pixels located on the diagonal line used to determine the D2 value for interpolation. Other options may be possible, such as random selection between the pixels used to determine D1 or D2, or bilinear interpolation of pixels used to determine both D1 and D2, and aspects of this disclosure should not be considered limited to the above example.

The result of the linear interpolation of the pixel values may be the pixel values for the interpolated center pixel (e.g., the value of the pixel of upscaled image 26 that corresponds to the location (2.5, 2.5) in image 24). For example, if D1 is less than D2, then display processor 22 may perform linear interpolation utilizing the pixel values of the pixels located at (2, 2) and (3, 3) in image 24 because these pixels form the diagonal line from which D1 is calculated.

If, however, the criterion of D1<Th and D2<Th is met, display processor 22 may determine the second order derivatives, in the first pass. Second order derivatives may be viewed as the curvature of pixels neighboring the interpolated center pixel. In this disclosure, the curvature of pixels may provide a measure of the amount of change between additional proximate pixels and the pixels used for determining the first order derivatives.

Furthermore, in alternate examples, display processor 22 may determine first order derivative values and second order derivative values in parallel, or first determine second order derivate values and then first order derivative values. For instance, display processor 22 may determine the first order derivative values and the second order derivative values in any order, or at the same time. This disclosure describes display processor 22 first determining the first order derivative values, and then determining the second order derivative values if the criterion of D1<Th and D2<Th is met. However, such disclosure is provided for purposes of illustration, and should not be considered as limiting.

In accordance with the example techniques, display processor 22 may determine two second order derivative values based on pixels that reside on diagonal lines, relative to the interpolated center pixel, that are parallel to the diagonal lines that included the pixels for determining D1 and D2. However, the pixels of these two diagonal lines, used to determine second order derivative values, may not necessarily be pixels that are immediately neighboring the interpolated center pixel. Also, similar to the first order derivative values, the diagonal lines that are used to determine the second order derivative lines includes pixels of image 24 whose x- and y-coordinates are different compared to other pixels on the diagonal lines.

As an example, as described above, display processor 22 determined the value Dl based on pixels located at (2, 2) and (3, 3) in image 24. The first curvature value (e.g., the first second order derivative value) may be based on the pixels located at (2, 1), (3, 2), and (4, 3) in image 24, and the pixels located at (1, 2), (2, 3), and (3, 4) in image 24. As may be seen when drawn out, the diagonal line that includes the pixels located at (2, 1), (3, 2), and (4, 3) in image 24 is parallel to the diagonal line that includes the pixels located at (2, 2) and (3, 3) in image 24. Also, the diagonal line that includes the pixels located at (1, 2), (2, 3), and (3, 4) in image 24 is parallel to the diagonal line that includes the pixels located at (2, 2) and (3, 3) in image 24.

To determine the first curvature value, display processor 22 may sum the pixel values of the pixels located at (2, 1), (3, 2), (4, 3), (1, 2), (2, 3), and (3, 4) of image 24, referred to as first value. Display processor 22 may also sum the pixels located at (2, 2) and (3, 3) in image 24 and multiply this resulting summed value by three, referred to as second value. Display processor 22 may then subtract the second value from the first value, and determine the absolute value of the resulting value. The resulting absolute value may be the value of the first curvature value (e.g., the first value of the second order derivative), referred to as C1.

Display processor 22 may similarly determine the second curvature value. For example, as described above, display processor 22 determined the value D1 based on pixels located at (2, 3) and (3, 2) in image 24. The second curvature value may be based on the pixels located at (1, 3), (2, 2), and (3, 1) in image 24, and the pixels located at (3, 4), (3, 3), and (4, 2) in image 24. As may be seen when drawn out, the diagonal line that includes the pixels located at (1, 3), (2, 2), and (3, 1) in image 24 is parallel to the diagonal line that includes the pixels located at (2, 3) and (3, 2) in image 24. Also, the diagonal line that includes the pixels located at (3, 4), (3, 3), and (4, 2) in image 24 is parallel to the diagonal line that includes the pixels located at (2, 3) and (3, 2) in image 24.

To determine the second curvature value, display processor 22 may sum the pixel values of the pixels located at (1, ), (2, 2), (3, 1), (3, 4), (3, 3), and (4, 2) in image 24, referred to as third value. Display processor 22 may also sum the pixels located at (2, 3) and (3, 2) in image 24 and multiply this resulting summed value by three, referred to as fourth value. Display processor 22 may then subtract the third value from the fourth value, and determine the absolute value of the resulting value. The resulting absolute value may be the value of the second curvature value (e.g., the second value of the second order derivative), referred to as C2.

Display processor 22 may then determine which one of C1 or C2 is less than the other. Display processor 22 may then determine which one of the diagonal lines used to determine D1 and D2 is parallel to the diagonal lines used to determine the lesser of C1 and C2. Display processor 22 may then perform interpolation on the pixel values that are for the pixels that make up the pixels on one of the diagonal lines used to determine D1 and D2. In this example, the interpolation may be weighted interpolation to determine the pixel values for the interpolated center pixel.

For example, assume that C1 is less than C2. In this example, display processor 22 may determine that the diagonal lines used to determine the C1 value are parallel to the diagonal line used to determine the D1 value. Display processor 22 may then utilize the pixels that reside along the diagonal used to determine the D1 value to interpolate the pixel values for the interpolated center pixel. In this example, because display processor 22 may utilize weighted interpolation, display processor 22 may determine the weights for the pixel values of the pixels that reside along the diagonal line used to determine the D1 value based on the pixel values of the pixels that reside along the diagonal lines used to determine the C1 value.

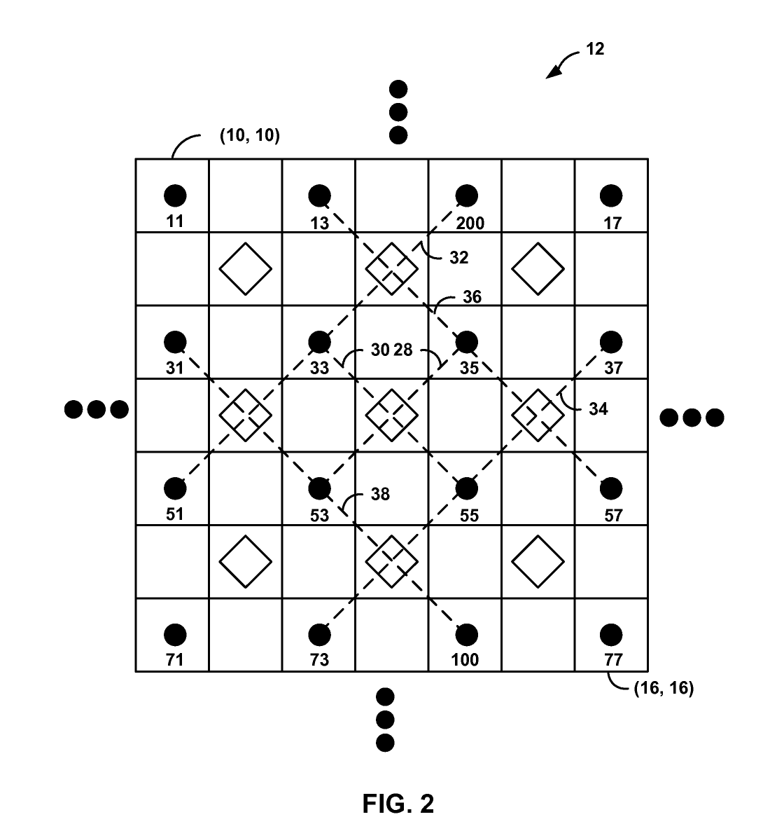

For example, display processor 22 may select the pixels that form the parallel diagonal lines used to calculate C1 (e.g., the pixels located at (2, 1), (3, 2), (4, 3), (1, 2), (2, 3), and (3, 4) in image 24). Display processor 22 may then determine the weights that are applied to the pixels located on the diagonal along (2, 2) and (3, 3) (e.g., the pixels used to determine the D1 value) in image 24 based on the pixel values of the pixels located at (2, 1), (3, 2), (4, 3), (1, 2), (2, 3), and (3, 4) in image 24, as described in more detail in the example illustrated in FIG. 2.

In some examples, it may be possible that C1 equals C2. For these cases, display processor 22 may be configured to perform weighted interpolation (as one example) using the pixel values for the pixels located on one of the diagonals that is parallel to the diagonal lines used to determine C1 and C2. For example, the diagonal line used to determine D1 is parallel to the diagonal lines used to determine C1. Similarly, the diagonal line used to determine D2 is parallel to diagonal lines used to determine C2. In some examples, display processor 22 may be configured to always select the pixels located on the diagonal line that is parallel to the diagonal lines used to determine C1 (e.g., the diagonal line used to determine the D1 value) for interpolation, or always select the pixels located on the diagonal line that is parallel to the diagonal lines used to determine C2 (e.g., the diagonal line used to determine the D2 value) for interpolation. Other options may be possible, such as random selection between the pixels used to determine D1 or D2, or bilinear interpolation based on pixels used to determine both D1 and D2, and aspects of this disclosure should not be considered limited to the above example.

After this process, display processor 22 may have determined the pixel values for the interpolated center value, and the first pass may be complete. Then, in the second pass, display processor 22 may then determine the pixel values for remaining interpolated pixels. Display processor 22 may apply similar techniques to those described above to determine the pixel values for the other interpolated pixels. However, display processor 22 may utilize the values determined in the first pass to determine the pixel values of the other interpolated pixels. Moreover, rather than utilizing pixels that reside on orthogonal diagonal lines, display processor 22 may utilize pixels located in orthogonal vertical and horizontal lines to determine the pixel values for the other interpolated pixels.

FIG. 2 is a graphical diagram illustrating an example of pixels located on a display and pixels of an image that are used to interpolate pixel values for an interpolated pixel. For example, FIG. 2 illustrates a block of pixels of display 12 (e.g., the square blocks of FIG. 2). In FIG. 2, the block of pixels of display 12 is a 7×7 block of pixels starting from coordinate (10, 10), and extending to (16, 16).

The black dots shown in FIG. 2 are pixels of image 24. For example, if display processor 22 were to display image 24 on the entirety of display 12 without any interpolation, image 24 would appear on display 12 as illustrated in FIG. 2. For example, because the resolution of image 24 is less than the resolution of display 12, without interpolation, there may be some pixels of display 12 for which there are no pixel values. For instance, there is no pixel in image 24 that corresponds to the pixel of display 12 located at (11, 11), and therefore, without interpolation there are no pixel values for the pixel located at (11, 11) in display 12.

FIG. 2 also illustrates hypothetical pixel values for the pixels of image 24. For example, below each black dot in FIG. 2, there is a numerical value. This numerical value is meant to illustrate a pixel value for its corresponding block dot (e.g., pixel of image 24). The illustrated pixel value may be any one of the pixel values. For example, the illustrated numerical values may be a numerical value for the red component of the RGB color value of each of the pixels, although these numerical values should not be construed to mean they can only be values for the red component. These values may be numerical values for any other pixel value as well. It should be understood that display 12 does not actually display these numerical values. Rather, display processor 22 utilizes these pixel values to determine the color of the pixel of display 12.

The pixels of display 12 for which there is no corresponding pixel in image 24 may be referred to as an interpolated pixel because display processor 22 may interpolate the pixel values for such pixels of display 12 utilizing selected pixels from image 24. As described above, display processor 22 may first interpolate pixel values for center pixels that are located on display 12 within a block of pixels of image 24. Again, it should be noted that the interpolated center pixel is a pixel that does not exist in image 24, but does exist on display 12.

For example, a center pixel, whose value display processor 22 interpolates, may be considered as a pixel where two diagonal and orthogonal lines intersect, where each line includes two pixels of image 24. In FIG. 2, the center pixels are illustrated as diamonds. For instance, the pixel of display 12, located at (13, 13), is a center pixel, whose values display processor 22 interpolates, because a diagonal line that extends from the pixels of image 24 located at (12, 14) and (14, 12) and a diagonal line that extends from the pixels of image 24 located at (12, 12) and (14, 14) intersect at (13, 13) in display 12.

In accordance with techniques of this disclosure, display processor 22 may interpolate the pixel values for the center pixels (e.g., the diamonds in FIG. 2) in the first pass. Display processor 22 may then interpolate the pixel values for the remaining pixels (e.g., the blank pixels that do not include a diamond or a block dot in FIG. 2). In some examples, in the first and second passes, display processor 22 may need pixel values from other neighboring blocks of pixels, which may be stored in memory 20 or in the local memory of display processor 22. For example, to interpolate the pixel values for the center pixel located at (11, 11) in display 12, display processor 22 may need pixel values for pixels from neighboring blocks of pixels, which may be stored in memory 20 or in the local memory of display processor 22. Also, during the second pass, display processor 22 may utilize the pixel values for the interpolated center pixels to interpolate the other pixels. Accordingly, for the second pass, display processor 22 may store the interpolated pixel values for the interpolated center pixels in memory 20 or in the local memory of display processor 22.

For purposes of illustration, the following is an example of the manner in which display processor 22 may interpolate the pixel values for the interpolated center pixel located at (13, 13) in display 12, in the first pass. For example, display processor 22 may determine first order derivative values of two diagonal lines, which are orthogonal relative to one another, and that each include two pixels of image 24. In this example of FIG. 2, the first diagonal line 28 is a diagonal line that extends from the pixel located at (12, 14) to (14, 12) in display 12, shown as a dashed line. The second diagonal line 30 is a diagonal line that extends from the pixel located at (12, 12) to (14, 14) in display 12, also shown as a dashed line. In this example, both the x- and y-coordinates for one pixel that resides on the first diagonal line 28 is different than the x- and y-coordinates for the other pixel that resides on the first diagonal line 28. Similarly, in this example, both the x- and y-coordinates for one pixel that resides on the second diagonal line 30 is different than the x- and y-coordinates for the other pixel that resides on the second diagonal line 30.

To determine the first order derivative values for the first diagonal line 28, display processor 22 may subtract the pixel value for the pixel located at (12, 14) (e.g., 53) from the pixel located at (14, 12) (e.g., 35), or vice-versa, and determine the absolute value of the resulting subtraction. This value may be referred to as D1. For example, the value of D1 may be 18 (e.g., absolute value of 53 minus 35).

To determine the first order derivative values for the second diagonal line 30, display processor 22 may subtract the pixel value for the pixel located at (12, 12) (e.g., 33) from the pixel located at (14, 14) (e.g., 55), or vice-versa, and determine the absolute value of the resulting subtraction. This value may be referred to as D2. For example, the value of D2 may be 22 (e.g., the absolute value of 53 minus 35).

Display processor 22 may then compare the D1 and D2 values to a threshold value (Th). If at least one of D1 and D2 is greater than the threshold value (e.g., the criterion that D1<Th and D2<Th is not met), display processor 22 may determine which one of D1 and D2 is smaller than the other. Display processor 22 may select the pixels of image 24 that reside on the diagonal line that resulted in the smaller first derivative values. Display processor 22 may utilize the pixel values for these selected pixels to interpolate the pixel values for the interpolated center pixel located at (13, 13) in display 12.

For example, assume that the threshold value is 20. In this case, at least one of D1 and D2 is greater than the threshold value (e.g., D2 is greater than 20). Display processor 22 may determine that D1 is less than D2 (e.g., 18 is less than 22). Display processor 22 may select the pixels located at (12, 14) and (14, 1) on display 12 because these pixels were used to determine the value of D1 (e.g., the pixels of the first diagonal line 28). In this example, display processor 22 may perform linear interpolation utilizing the pixel values for the pixels located at (12, 14) and (14, 12) (e.g., 53 and 35, respectively, to interpolate the pixel values for the interpolated pixel (e.g., the pixel located at (13, 13) in display 12).

If both D1 and D2 are less than the threshold value, then display processor 22 may utilize proximate pixels to the interpolated pixel to interpolate the pixel values for the interpolated pixel. Proximate pixels may be pixels that neighbor the interpolated center pixel, but may not necessarily immediately neighbor the interpolated center pixel. In this sense, proximate pixels encompass both pixels that are proximate to the interpolated center pixel and pixels that are immediately neighboring the interpolated center pixel. However, not all proximate pixels are pixels that are immediately neighboring the interpolated center pixel, but some may be.

Display processor 22 may determine which of these proximate pixels to utilize for interpolation based on second order derivative values, also referred to as curvature values. For example, these proximate pixels reside on two diagonal lines that are parallel to the diagonal line used to determine the D1. These proximate pixels also reside on two diagonal lines that are parallel to the diagonal line used to determine D2. In other words, there may be four diagonal lines used to determine second order derivative values. Two of the four diagonal lines are parallel to one another, and parallel to the diagonal line used to determine D1. Display processor 22 may utilize these two parallel lines of the four diagonal parallel lines to determine a first value of the second order derivative (e.g., a first curvature value). The other two of the four diagonal lines are parallel to one another, and parallel to the diagonal line used to determine D2. Display processor 22 may utilize these two parallel lines of the four diagonal parallel lines to determine a second value of the second order derivative (e.g., a second curvature value).

Also, one or more of these proximate pixels may not immediately neighbor the interpolated center pixel. However, some of these proximate pixels may immediately neighbor the interpolated center pixels. For example, to determine the D1 and D2 values, display processor 22 utilized pixels that are located at (12, 14), (14, 12), (12, 12), and (14, 14). All of these pixels immediately neighbor the interpolated center pixel located at (13, 13). In the examples of this disclosure, at least one of the pixel that is used to determine the second order derivative values does not immediately neighbor the interpolated center pixel located at (13, 13). It may be possible for at least one other pixel that is used to determine the second order derivative values to immediately neighbor the interpolated center pixel located at (13, 13).

As described above, the diagonal lines that are used to determine the first order derivative values (e.g., the D1 and D2 values) were referred to as a first diagonal line 28 and a second diagonal line 30, respectively. To avoid confusion, the diagonal lines that are used to determine a first curvature value (e.g., a first value of the second order derivative) are referred to as a third diagonal line 32 and a fourth diagonal line 34, respectively. The diagonal lines that are used to determine a second curvature value (e.g., a second value of the second order derivative) are referred to as a fifth diagonal line 36 and a sixth diagonal line 38.

For example, in FIG. 2, the third diagonal 32 line may include pixels located at (10, 14), (12, 12), and (14, 10), shown as a dashed line. This third diagonal line 32 is parallel to the first diagonal line 28. Also, the x- and y-coordinates of each of the pixels that resides along the third diagonal line 32 is different relative to x- and y-coordinates of other pixels that reside along the third diagonal line 32. In FIG. 2, the fourth diagonal line 34 may include pixels located at (12, 16), (14, 14), and (16, 12). This fourth diagonal line 34 is parallel to both the first diagonal line 28 and the third diagonal line 32. Similar to the third diagonal line 32, the x- and y-coordinates of each of the pixels that resides along the fourth diagonal line 34 is different relative to x- and y-coordinates of other pixels that reside along the fourth diagonal line 34.

In FIG. 2, the fifth diagonal line 36 may include pixels located at (12, 10), (14, 12), and (16, 14), shows as a dashed line. This fifth diagonal line 36 is parallel to the second diagonal line 30. Also, the x- and y-coordinates of each of the pixels that resides along the fifth diagonal line 36 is different relative to x- and y-coordinates of other pixels that reside along the fifth diagonal line 36. In FIG. 2, the sixth diagonal line 38 may include pixels located at (10, 12), (12, 14), and (14, 16). This sixth diagonal line 38 is parallel to both the second diagonal line 30 and the fifth diagonal line 36. Similar to the fifth diagonal line 36, the x- and y-coordinates of each of the pixels that resides along the sixth diagonal line 38 is different relative to x- and y-coordinates of other pixels that reside along the sixth diagonal line 38.

Display processor 22 may determine the first curvature value based on the pixel values for the pixels that reside on the third diagonal line 32, the fourth diagonal line 34, and the first diagonal line 28. To determine the first curvature value, referred to as C1, display processor 22 may sum the pixel values for the pixels that reside along the third diagonal line 32 and sum the pixel values for the pixels that reside along the first diagonal line 28, and subtract sum of pixel values for the pixels that reside along the first diagonal line 28 from the sum of the pixel values for the pixels that reside along the third diagonal line 32. For example, in the example of FIG. 2, this can be represented as: (51+33+200)−(53+35), and referred to as C1_1.

To determine the value of C1, display processor 22 may sum the pixel values for the pixels that reside along the fourth diagonal line 34 and sum the pixel values for the pixels that reside along the first diagonal line 28, and subtract the sum of the pixel values for the pixels that reside along the first diagonal line 28 from the sum of the pixel values for the pixels that reside along the fourth diagonal line 34. For example, in the example of FIG. 2, this can be represented as: (73+55+37)−(53+35), and referred to as C1_2.

Display processor 22 may then sum C1_1 and C1_2 and subtract the sum of the pixel that reside along the first diagonal line 28 from the resulting value. For example, display processor 22 may perform the following function: (C1_1+C1_2)−(53+35). The value of C1 (e.g., the first curvature value or the first value of the second order derivative) may be the absolute value of the result of (C1_1+C1_2)−(53+35). The above operations to determine the value of C1, in the example of FIG. 2, may be simplified to:

C1=|(51+33+200+73+55+37)−3(53+35)|.

Display processor 22 may determine the second curvature value, referred to as C2, based on the pixel values for the pixels that reside on the fifth diagonal line 36, the sixth diagonal line 38, and the second diagonal line 30, in a manner similar to determining the value of C1. For example, display processor 22 may sum the pixel values for the pixels that reside along the fifth diagonal line 36 and sum the pixel values for the pixels that reside along the second diagonal line 30, and subtract the sum of the pixel values for the pixels that reside along the second diagonal line 30 from the sum of the pixel values for the pixels that reside along the fifth diagonal line 36. For example, in the example of FIG. 2, this can be represented as: (13+35+57)−(33+55), and referred to as C2_1.

To determine the value of C2, display processor 22 may sum the pixel values for the pixels that reside along the sixth diagonal line 38 and sum the pixel values for the pixels that reside along the second diagonal line 30, and subtract the sum of the pixel values for the pixels that reside along the second diagonal line 30 from the sum of the pixel values for the pixels that reside along the sixth diagonal line 38. For example, in the example of FIG. 2, this can be represented as: (31+53+100)−(33+55), and referred to as C2_2.

Display processor 22 may then sum C2_1 and C2_2 and subtract the sum of the pixel that reside along the second diagonal line 30 from the resulting value. For example, display processor 22 may perform the following function: (C2_1+C2_2)−(3+55). The value of C2 (e.g., the second curvature value or the second value of the second order derivative) may be the absolute value of the result of (C2_1+C2_2)−(33 +55). The above operations to determine the value of C2, in the example of FIG. 2, may be simplified to:

C2=|(13+35+57+31+53+100)−3(33+55)|.

To determine which pixels to use for interpolation, when the criterion that D1<Th and D2<Th is met, display processor 22 may determine which one of C1 and C2 is lesser than the other. For instance, in the example of FIG. 2, C1 equals 185, and C2 equals 25. Therefore, in this example, display processor 22 determines that C2 is less than C1

Display processor 22 may select the pixels, which are immediately neighboring the interpolated center pixel, that were used to determine the value of the less of C1 and C2 for interpolation. For instance, in the example of FIG. 2 where C2 is less than C1, the pixels that were used to determine D2 are the pixels that were used to determine the value of C2. Accordingly, display processor 22 may utilize the pixels that reside along the second diagonal line 30 to interpolate the pixel values of the interpolated center pixel (e.g., the pixel located at (13, 13) in display 12).

As described above, when the D1<Th and D2<Th criterion is not met, display processor 22 may employ a linear interpolation to interpolate the pixel values for the interpolated center pixel. This linear interpolation may be referred to as a first interpolation type. In some examples, when the D1<Th and D2<Th criterion is met, display processor 22 may employ a second, different interpolation type. For example, this second, different interpolation type may be a weighted interpolation. However, aspects of this disclosure are not so limited. In alternate examples, display processor 22 may employ the same interpolation type whether the D1<Th and D2<Th criterion is met or not met. Also, the linear interpolation and weighted interpolation are provided as examples, and should not be considered limiting.

In the example of FIG. 2, when the D1<Th and D2<Th criterion is met, display processor 22 may employ a weighted interpolation utilizing the pixels that reside along the second diagonal line 30 to interpolate the pixel values of the interpolated center pixel, as described above. In the example of FIG. 2, the pixels that reside along second diagonal line 30 are pixels located at (12, 12) and (14, 14). In this example, display processor 22 may determine the weighting to be applied to the pixel values for the pixel located at (12, 12) and the weighting to be applied to the pixel values for the pixel located at (14, 14). The weighting value to be the applied to the pixel located at (12, 12) may be referred to as W1, and the weighting value to be applied to the pixel located at (14, 14) may be referred to as W2.

Display processor 22 may determine the values of W1 and W2 based on the pixel values of pixels used to determine the value of C2 (e.g., the pixel values for the pixel that reside along the fifth diagonal line 36, sixth diagonal line 38, and the second diagonal line 30. As one example, the value of W1 may be based on the values of the pixels that reside along the fifth diagonal line 36 and the second diagonal line 30, and the value of W2 may be based on the values of the pixels that reside along the sixth diagonal line 38 and the second diagonal line 30.

In the example of FIG. 2, the fifth diagonal line 36 includes pixels located at (12, 10), (14, 12), and (16, 14), and the second diagonal line 30 includes pixels located at (12, 12) and (14, 14). To determine the value of W1, display processor 22 may sum the pixel values for the pixels located at (12, 10) and (14, 12) (e.g., pixels that reside along the fifth diagonal line 36), and subtract the sum the pixel values for the pixels located at (12, 12) and (14, 14) (e.g., pixels that reside along the second diagonal line 30) from the resulting value. For instance, in the example of FIG. 2, display processor 22 may perform the following operation: (13+35)−(33+55), referred to as W1_1.

To determine the value of W1, display processor 22 may also sum the pixel values for the pixels located at (14, 12) and (16, 14) (e.g., pixels that reside along the fifth diagonal line 36), and subtract the sum the pixel values for the pixels located at (12, 12) and (14, 14) (e.g., pixels that reside along the second diagonal line 30) from the resulting value. For instance, in the example of FIG. 2, display processor 22 may perform the following operation: (35+57)−(33+55), referred to as W1_2.

Display processor 22 may sum the values of W1_1 and W1_2 and determine the absolute value of the resulting value. This resulting absolute value may be the value of W1. For example, W1=|W1_1+W1_21. In the example of FIG. 2, the operations to determine the value of W1 may be simplified to:

W1=|13+57+2*35−2(33+55)|.

Display processor 22 may utilize a similar technique to determine the value of W2. For instance, in the example of FIG. 2, the sixth diagonal line 38 includes pixels located at (10, 12), (12, 14), and (14, 16), and the second diagonal line 30 includes pixels located at (12, 12) and (14, 14). To determine the value of W2, display processor 22 may sum the pixel values for the pixels located at (10, 12) and (12, 14) (e.g., pixels that reside along the sixth diagonal line 38), and subtract the sum the pixel values for the pixels located at (12, 12) and (14, 14) (e.g., pixels that reside along the second diagonal line 30) from the resulting value. For instance, in the example of FIG. 2, display processor 22 may perform the following operation: (31+53)−(33+55), referred to as W2_1.

To determine the value of W2, display processor 22 may also sum the pixel values for the pixels located at (12, 14) and (14, 16) (e.g., pixels that reside along the sixth diagonal line 38), and subtract the sum the pixel values for the pixels located at (12, 12) and (14, 14) (e.g., pixels that reside along the second diagonal line 30) from the resulting value. For instance, in the example of FIG. 2, display processor 22 may perform the following operation: (53+100)−(33+55), referred to as W2_2.

Display processor 22 may sum the values of W2_1 and W2_2 and determine the absolute value of the resulting value. This resulting absolute value may be the value of W2. For example, W2=|W2_1+W2_2|. In the example of FIG. 2, the operations to determine the value of W2 may be simplified to:

Display processor 22 may apply the value of W1 to the pixel located at (14, 12), and apply the value of W2 to the pixel located at (12, 14). Then, display processor 22 may interpolated the pixel values for the interpolated center pixel based on the applied weights. The equation to determine the pixel value of the interpolated center pixel located at (13, 13) may be:

P(13, 13)=[(1/(1+W1))*P(14, 12)+(1/(1+W2))*P(12, 14)]/[(1/(1+W1))+(1/(1+W2))], where P(13, 13) equals the interpolate pixel value for the pixel located at (13,13), P(14, 12) equals the pixel value of the pixel located at (14, 12) (e.g., 35), and P(12, 14) equals the pixel value of the pixel located at (12, 14) (e.g., 53).

The above examples to determine the values of W1 and W2 are based on the situation when C2 is less than C1, as is the case based on the example pixel values provided for the example of FIG. 2. In a case where the value of C1 were less than the value of C2, display processor 22 may determine weighting values in a manner similar to that described above. For example, display processor 22 may determine the weighting values using the pixel values for the pixels that reside along the third diagonal line 32, the fourth diagonal line 34, and the first diagonal line 28. The equations to determine these weighting values are provided below, and referred to as W3 and W4 to avoid confusion with the weighting values W1 and W2.

W3=|51+200+2*33−2(53+35)|.

W4=|73+37+2*55−2(53+35)|.

In this manner, display processor 22 may interpolate the pixel values for the interpolated center pixel located at (13, 13) in display 12. For example, display processor 22 may determine D1 and D2 values based on pixels immediately neighboring the interpolated center pixel, as described above. When at least one of D1 and D2 is greater than Th (e.g., the criterion D1<Th and D2<Th is not met), display processor 22 may select the immediately neighboring pixels of image 24 that were used to determine the value of the lesser of D1 and D2, and perform interpolation of a first interpolation type (e.g., linear interpolation).

If both D1 and D2 are less than Th (e.g., the criterion D1<Th and D2<Th is met), display processor 22 may determine the values of C1 and C2, as described above. For example, the values of C1 and C2 may be based on one or more pixels that neighbor and immediately neighbor the interpolated center pixel. Display processor 22 may select the immediately neighboring pixels of image 24 that were used to determine the value of the lesser of C1 and C2, and perform interpolation of a second interpolation type (e.g., weighted interpolation). In this case, display processor 22 may also determine the weighting that is to be applied to selected pixels. The weighting is based on the pixels that reside along the diagonal lines that were used to determine the lesser of the C1 and C2 values.

In the first pass, display processor 22 may similarly interpolate pixel values for the other interpolated center pixels. For instance, in the example of FIG. 2, display processor 22 may similarly interpolate the pixel values for the pixels located at: (11, 11), (13, 11), (15, 11), (11, 13), (15, 13), (11, 15), (13, 15), and (15, 15). In accordance with the example techniques, the interpolation of the pixel values for the interpolated center pixels completes the first pass of the two pass techniques. In the second pass, display processor 22 may interpolate pixel values for the other interpolated pixels.

For instance, in the example of FIG. 2, the other interpolated pixels are pixels of display 12 that do not include a black dot or a diamond (e.g., the blank pixels). To interpolate the pixel values for these other interpolated pixels (e.g., non-center interpolated pixels), display processor 22 may perform functions substantially similar to the above described techniques. However, rather than using pixels that reside on diagonal lines to perform the interpolation, display processor 22 may utilize pixels that reside on orthogonal vertical and horizontal lines. Also, in interpolating the pixel values for these other interpolated pixels, display processor 22 may utilize the interpolated pixel values for the interpolated center pixels.

As one example, to interpolate the pixel values for the interpolated pixel located at (13, 12) in display 12, display processor 22 may determine a first order derivative value based on pixels that reside along a horizontal line that intersects the pixel located at (13, 12). A horizontal line may be a line of pixels where the y-coordinate for each of the pixels is the same, and the x-coordinate is different. For example, in the example of

FIG. 2, the horizontal line that intersects the pixel located at (13, 12) includes the pixels located at (12, 12) and (14, 12). Display processor 22 may determine the first order derivative value based on the pixel values for the pixels located at (12, 12) and (14, 12). This value may be the first value of the first order derivative, which can be considered to be similar to the D1 value described above.

Display processor 22 may also determine a first order derivative value based on pixels that reside along a vertical line that intersects the pixel located at (13, 12). A vertical line may be a line of pixels where the x-coordinate for each of the pixels is the same, and the y-coordinate is different. For example, in the example of FIG. 2, the vertical line that intersects the pixel located at (13, 12) includes the pixels located at (13, 11) and (13, 13). This value may be the second value of the first order derivative, which can be considered to be similar to the D2 value described above. In this example, display processor 22 may have already interpolated the pixel values for the pixels located at (13, 11) and (13, 13) in the first pass.

In this example, display processor 22 may determine whether both of the first order derivative values are less than the threshold value. If at least one of the first order derivative values is greater than the threshold value, display processor 22 may perform the linear interpolation as described above. If both of the first order derivative values are less than the threshold value, display processor 22 may determine the two curvature values in a manner similar to that described above with respect to determining the values of C1 and C2. However, in this example, display processor 22 may determine the two curvature values (e.g., the two second order derivative values) based on parallel horizontal and vertical lines.

When both the first order derivative values are less than the threshold value, when interpolating the pixel values for the non-center interpolated pixel, display processor 22 may select which pixels to use for interpolation based on the lesser of the second order derivative values. Display processor 22 may perform weighted interpolation as described above based on which pixels were used to determine the value for the lesser of the second order derivative values. Display processor 22 may determine the weighting values in a manner similar to that described above in determining the values of W1, W2, W3, and W4. However, in this case, display processor 22 may utilize vertical and horizontal lines to determine the weighting values.

Display processor 22 may utilize similar techniques (e.g., with horizontal and vertical lines) to interpolate the pixel values for the non-center interpolated pixels. The interpolation of the pixel values for the non-center interpolated pixels may complete the second pass of the two-pass technique. Display processor 22 may utilize the two-pass technique in a similar way to interpolate other blocks of pixels other than the one illustrated in FIG. 2. After the completion of the two-pass techniques for the other blocks of pixels, the resulting pixel values may be the pixel values for upscaled image 26. However, this may not be the case in every example

In some examples, after display processor 22 utilizes the two-pass technique on all of the blocks of pixels, the resulting resolution of the upscaled image may possibly be less than the resolution of display 12. In these situations, display processor 22 may keep repeating the two-pass technique until the resolution of the upscaled image is the same as the resolution of display 12. In these examples, upscaled image 26 may be the resulting image after display processor 22 repeats the two-pass technique so that resolution of upscaled image 26 is the same as the resolution of display 12. For example, display processor 22 may determine whether the resolution of the upscaled image is equal to the resolution of display 12, and if it is not, display processor 22 may repeat the two-pass technique using the interpolated pixel values for subsequent turns through the two-pass technique.

Furthermore, in some examples, resolution of display 12 may not be a dyadic factor. In these situations, display processor 12 may repeat the two-pass technique until the resolution of the upscaled image by the greatest dyadic factor that is less than the resolution of display 12. Then, display processor 22 may re-sample the upscaled image and utilize multi-phase interpolation technique to increase the resolution of the upscaled image to be equal to the resolution of display 12. Display processor 22 may utilize any re-sampling and multi-phase interpolation technique to achieve the desired resolution after display processor 12 utilizes the two-pass technique described in this disclosure. The resulting image (e.g., after the multi-phase interpolation) may be upscaled image 26.

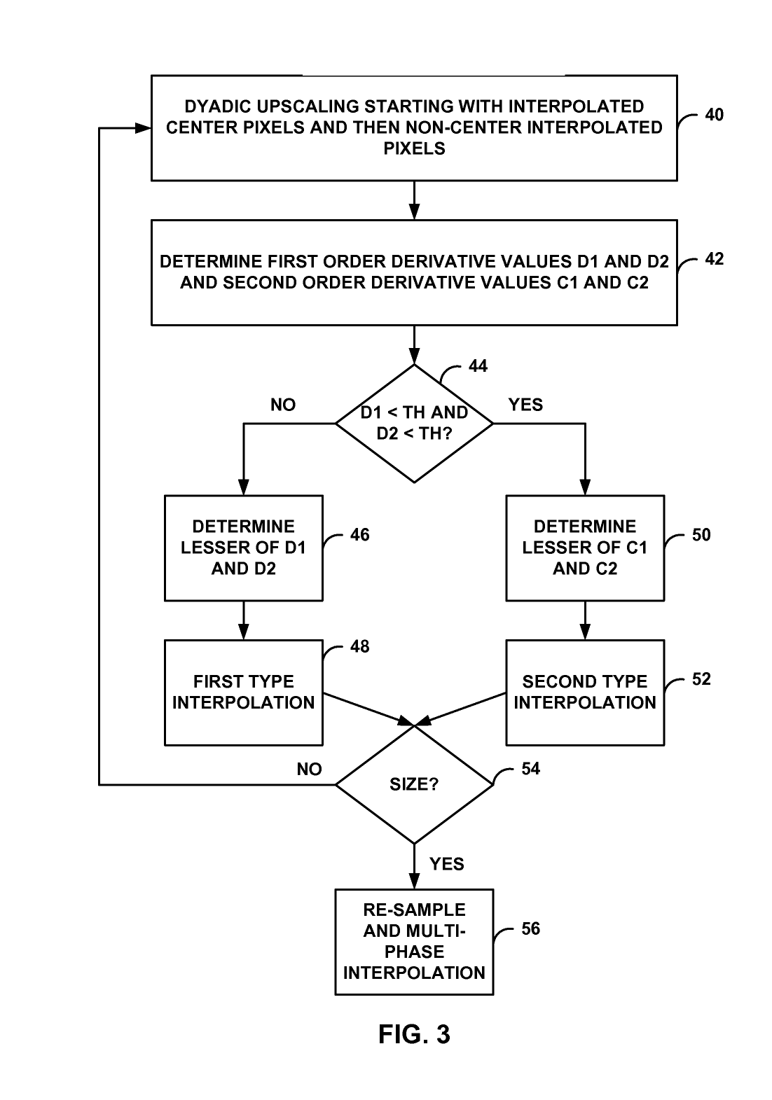

FIG. 3 is a flowchart illustrating example techniques in accordance with one or more examples described in this disclosure. For purposes of illustration only, reference is made to FIGS. 1 and 2. Also, not all of the steps illustrated in FIG. 3 need to be performed in every instance. One or more steps may not be performed, or may be performed in an order different than that illustrated in FIG. 3.

In the example of FIG. 3, a processing unit, such as display processor 22, may start with interpolating pixel values for interpolated center pixels and then interpolate pixel values for non-center interpolated pixels (40). For example, the processing unit may determine first order derivative values (e.g., D1 and D2) and second order derivative values (e.g., C1 and C2) for an interpolated center pixel (42) within a block of pixels. If the processing unit already interpolated the pixel values for all of the interpolated center pixels in a block of pixels, the processing unit may determine first and second order derivative values for the non-center interpolated pixels.

The processing unit may determine the first order derivative values and the second order derivative values in the manner described above. For instance, for the interpolated center pixel, the processing unit may utilize immediately neighboring pixels that reside along orthogonal diagonal lines to determine the first order derivative values. For the non-center interpolated pixels, the processing unit may utilize immediately neighboring pixels that reside along orthogonal vertical and horizontal lines to determine the first order derivative values. For the interpolated center pixel, the processing unit may utilize diagonal lines that are parallel to the diagonal lines used to determine the first order derivative values to determine second order derivative values. For the non-center interpolated pixel, the processing unit may utilize vertical and horizontal lines that are parallel to the vertical and horizontal lines used to determine the first order derivative values to determine second order derivative values.

In some examples, the processing unit may not determine the first order derivative values and the second order derivative values at the same time. For instance, the processing unit may determine the first order derivative values, and determine the second order derivative values when both of the first order derivative values are less than a threshold value.

The processing unit may determine whether both of the first order derivative values are less than a threshold value (Th) (44). When at least one of the first order derivative values is greater than Th (“NO” branch of 44), the processing unit may determine the lesser of the first order derivative values D1 and D2 (46). The processing unit may perform a first type of interpolation using the pixels that immediately neighbor the interpolated pixel (e.g., either the interpolated center pixel or the non-center interpolated pixel) that were used to determine the value of the lesser of the first order derivative values (48). When both of the first order derivative values is less than Th (“YES” branch of 44), the processing unit may determine the lesser of the second order derivative values C1 and C2 (50). The processing unit may perform a second type of interpolation using the pixels that immediately neighbor the interpolated pixel (e.g., either the interpolated center pixel or the non-center interpolated pixel) that were used to determine the value of the lesser of the second order derivative values (52).

In some examples, the first interpolation type may be a linear interpolation and the second interpolation type may be weighted interpolation. For weighted interpolation, the processing unit may further determine weighting values for the pixels that are selected for interpolation. The processing unit may determine the weighting values based on pixel values that were used to determine the second order derivative values.

The processing unit may determine whether the size of the resulting upscaled image is the greatest dyadic factor it can be and still less than the size of display 12 (54). The processing unit may make this determination in examples where the resolution of display 12 is not a dyadic factor. In examples where the size of display 12 is a dyadic factor, the processing unit may determine whether the resolution of the resulting upscaled image is equal to the size of display 12.

In either case, if the result of the determination is negative (“NO” branch of 54), the processing unit may repeat the dyadic expansion of FIG. 3. If the result of the determination is positive (“YES” branch of 54), in some examples, the processing unit may re-sample the upscaled image and perform multi-phase interpolation so that the resulting upscaled image is the size of display 12 (56). The resulting image may be upscaled image 26. However, in examples where the size of display 12 is a dyadic factor, the processing unit may not need to re-sample and perform multi-phase interpolation. In these examples, when the size of the upscaled image is the same as the size of display 12, the resulting upscaled image may upscaled image 26.

FIG. 4 is a block illustrating another example of a device that may be operable to implement one or more aspects of this disclosure. For example, FIG. 4 illustrates device 10 of FIG. 1 in greater detail. For purposes of brevity, only the components of device 10 that are illustrated in FIG. 4, but not illustrated in FIG. 1 are described in detail.

In the example of FIG. 4, device 10 may include display 12, video processor 14, GPU 16, video codec 18, memory 20, display processor 22, transceiver module 58, user interface 60, and processor 62. Processor 62 may be the central processing unit (CPU) of device 10. Although this disclosure describes display processor 22 as implementing the example techniques described in this disclosure, it may be possible for any processing unit of device 10 to implement the example techniques. The processing unit may be one or more of processor 62, video processor 14, GPU 16, video codec 18, and display processor 22, or some other processing unit not illustrated in FIGS. 1 and 4.

Device 10 may include additional modules or units not shown in FIG. 4 for purposes of clarity. For example, device 10 may include a speaker and a microphone, neither of which are shown in FIG. 4, to effectuate telephonic communications in examples where device 10 is a mobile wireless telephone, or a speaker where device 10 is a media player. Device 10 may also include a video camera. Furthermore, the various modules and units shown in device 10 may not be necessary in every example of device 10. For example, user interface 60 and display 12 may be external to device 10 in examples where device 10 is a desktop computer or other device that is equipped to interface with an external user interface or display.

Examples of user interface 60 include, but are not limited to, a trackball, a mouse, a keyboard, and other types of input devices. User interface 60 may also be a touch screen and may be incorporated as a part of display 12. Transceiver module 58 may include circuitry to allow wireless or wired communication between device 10 and another device or a network. Transceiver module 58 may include modulators, demodulators, amplifiers and other such circuitry for wired or wireless communication.

In one or more examples, the functions described may be implemented in hardware, software, firmware, or any combination thereof. If implemented in software, the functions may be stored as one or more instructions or code on a computer-readable medium. Computer-readable media may include computer data storage media. Data storage media may be any available media that can be accessed by one or more computers or one or more processors to retrieve instructions, code and/or data structures for implementation of the techniques described in this disclosure. By way of example, and not limitation, such computer-readable media can comprise random access memory (RAM), read-only memory (ROM), EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (i.e., a chip set). Various components, modules or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
determining a first value based on pixel values of pixels that neighbor an interpolated center pixel of a display and that reside along a first diagonal line, wherein both x- and y-coordinates for the pixels that reside along the first diagonal line are different from one another;
determining a second value based on pixel values of pixels that neighbor the interpolated center pixel of the display that reside along a second line that is orthogonal to the first line, wherein both x- and y-coordinates for the pixels that reside along the second line are different from one another;
comparing the first value and the second value to a threshold value; and
when at least one of the first value and the second value is greater than the threshold value, performing an interpolation based at least on one of pixel values of the pixels that reside along the first diagonal line and pixel values of the pixels that reside along the second diagonal line to interpolate a pixel value for the interpolated center pixel of the display.

2. The method of claim 1, wherein the first value comprises a first order derivative of pixel values of at least two pixels that reside along the first diagonal line, wherein the first order derivative of the pixel values of the at least two pixels that reside along the first diagonal line comprises a subtraction between a pixel value of a first one of the at least two pixels and a pixel value of a second one of the at least two pixels that each reside along the first diagonal line, wherein the second value comprises a first order derivative of pixel values of at least two pixels that reside along the second diagonal line, and wherein the first order derivative of pixel values of the at least two pixels that reside along the second diagonal line comprises a subtraction between a pixel value of a first one of the at least two pixels and a pixel value of a second one of the at least two pixels that each reside along the second diagonal line.

3. The method of claim 1, further comprising:
when at least one of the first value and the second value is greater than the threshold value, determining a lesser value between the first value and the second value, wherein, when the first value is determined to be less than the second value, performing the interpolation comprises performing the interpolation based on pixel values of the pixels that reside along the first line and immediately neighbor the interpolated center pixel to determine the pixel value for the interpolated center pixel; and
wherein, when the second value is determined to be less than the first value, performing the interpolation comprises performing the interpolation based on pixel values of the pixels that reside along the second line and immediately neighbor the interpolated center pixel to determine the pixel value for the interpolated center pixel.

4. The method of claim 1, wherein performing the interpolation comprises performing a linear interpolation.

5. The method of claim 1, wherein performing the interpolation comprises performing a first type of interpolation, the method further comprising:
determining a third value based on pixel values of pixels that neighbor the interpolated center pixel and that reside along a third diagonal line that is parallel to the first diagonal line, and pixel values of pixels that neighbor the interpolated center pixel and that reside along a fourth diagonal line that is parallel to the first diagonal line and the third diagonal line, wherein both x- and y-coordinates for the pixels that reside along the third diagonal line are different from one another, and wherein both x- and y-coordinates for the pixels that reside along the fourth diagonal line are different from one another;
determining a fourth value based on pixel values of pixels that neighbor the interpolated center pixel and that reside along a fifth diagonal line that is parallel to the second diagonal line, and pixel values of pixels that neighbor the interpolated center pixel and that reside along a sixth diagonal line that is parallel to the second diagonal line and the fifth diagonal line, wherein both x- and y-coordinates for the pixels that reside along the fifth diagonal line are different from one another, and wherein both x- and y-coordinates for the pixels that reside along the sixth diagonal line are different from one another; and
when the first value and the second value are less than the threshold value, performing a second type of interpolation based at least on one of pixel values of the pixels that reside along the third and fourth diagonal lines and pixel values of the pixels that reside along the first diagonal line, and pixel values of the pixels that reside along the fifth and sixth diagonal lines and pixel values of the pixels that reside along the second diagonal line to determine the pixel values for the interpolated center pixel.

6. The method of claim 5, wherein the third value comprises a second order derivative of pixel values of at least two pixels that reside along the third diagonal line, at least two pixels that reside alone the fourth diagonal line, and at least two pixels that reside along the first diagonal line, and wherein the fourth value comprises a second order derivative of pixel values of at least two pixels that reside along the fifth diagonal line, at least two pixels that reside along the sixth diagonal line, and at least two pixels that reside along the second diagonal line.

7. The method of claim 5, further comprising:
when the first value and the second value are less than the threshold value, determining a lesser value between the third value and the fourth value,
wherein, when the third value is determined to be less than the fourth value, performing the second type of interpolation comprises performing the second type of interpolation based on pixel values of the pixels that reside along the first diagonal line and immediately neighbor the interpolated center pixel to determine the pixel values for the interpolated center pixel, and
wherein, when the fourth value is determined to be less than the third value, performing the second type of interpolation comprises performing the second type of interpolation based on pixel values of the pixels that reside along the second diagonal line and immediately neighbor the interpolated center pixel to determine the pixel values for the interpolated center pixel.

8. The method of claim 7, wherein the second type of interpolation comprises a weighted interpolation, and wherein values for weights of the weighted interpolation are based at least on one of the pixel values of the pixels that reside along the third and fourth diagonal lines and the pixel values of the pixels that reside along the first diagonal line, and the pixel values of the pixels that reside along the fifth and sixth diagonal lines and the pixel values of the pixels that reside along the second diagonal line.

9. The method of claim 1, further comprising:
performing interpolation based on the pixel values for the interpolated center pixel to determine pixel values for other non-center interpolated pixels.

10. An apparatus comprising:
a display that includes an interpolated center pixel; and
a processing unit operable to:
determine a first value based on pixel values of pixels that neighbor an interpolated center pixel of the display and that reside along a first diagonal line, wherein both x- and y-coordinates for the pixels that reside along the first diagonal line are different from one another;
determine a second value based on pixel values of pixels that neighbor the interpolated center pixel of the display that reside along a second line that is orthogonal to the first line, wherein both x- and y-coordinates for the pixels that reside along the second line are different from one another;
compare the first value and the second value to a threshold value; and
when at least one of the first value and the second value is greater than the threshold value, perform an interpolation based at least on one of pixel values of the pixels that reside along the first diagonal line and pixel values of the pixels that reside along the second diagonal line to interpolate a pixel value for the interpolated center pixel of the display.

11. The apparatus of claim 10, wherein the first value comprises a first order derivative of pixel values of at least two pixels that reside along the first diagonal line, wherein the first order derivative of the pixel values of the at least two pixels that reside along the first diagonal line comprises a subtraction between a pixel value of a first one of the at least two pixels and a pixel value of a second one of the at least two pixels that each reside along the first diagonal line, wherein the second value comprises a first order derivative of pixel values of at least two pixels that reside along the second diagonal line, and wherein the first order derivative of pixel values of the at least two pixels that reside along the second diagonal line comprises a subtraction between a pixel value of a first one of the at least two pixels and a pixel value of a second one of the at least two pixels that each reside along the second diagonal line.

12. The apparatus of claim 10,
wherein, when at least one of the first value and the second value is greater than the threshold value, the processing unit is operable to determine a lesser value between the first value and the second value,
wherein, when the first value is determined to be less than the second value, the processing unit is operable to perform the interpolation based on pixel values of the pixels that reside along the first line and immediately neighbor the interpolated center pixel to determine the pixel value for the interpolated center pixel; and
wherein, when the second value is determined to be less than the first value, the processing unit is operable to perform the interpolation based on pixel values of the pixels that reside along the second line and immediately neighbor the interpolated center pixel to determine the pixel value for the interpolated center pixel.

13. The apparatus of 10, wherein the processing unit is operable to perform linear interpolation.

14. The apparatus of claim 10, wherein the interpolation comprises a first type of interpolation, and wherein the processing unit is operable to:
determine a third value based on pixel values of pixels that neighbor the interpolated center pixel and that reside along a third diagonal line that is parallel to the first diagonal line, and pixel values of pixels that neighbor the interpolated center pixel and that reside along a fourth diagonal line that is parallel to the first diagonal line and the third diagonal line, wherein both x- and y-coordinates for the pixels that reside along the third diagonal line are different from one another, and wherein both x- and y-coordinates for the pixels that reside along the fourth diagonal line are different from one another;
determine a fourth value based on pixel values of pixels that neighbor the interpolated center pixel and that reside along a fifth diagonal line that is parallel to the second diagonal line, and pixel values of pixels that neighbor the interpolated center pixel and that reside along a sixth diagonal line that is parallel to the second diagonal line and the fifth diagonal line, wherein both x- and y-coordinates for the pixels that reside along the fifth diagonal line are different from one another, and wherein both x- and y-coordinates for the pixels that reside along the sixth diagonal line are different from one another; and
when the first value and the second value are less than the threshold value, perform a second type of interpolation based at least on one of pixel values of the pixels that reside along the third and fourth diagonal lines and pixel values of the pixels that reside along the first diagonal line, and pixel values of the pixels that reside along the fifth and sixth diagonal lines and pixel values of the pixels that reside along the second diagonal line to determine the pixel values for the interpolated center pixel.

15. The apparatus of claim 14, wherein the third value comprises a second order derivative of pixel values of at least two pixels that reside along the third diagonal line, at least two pixels that reside alone the fourth diagonal line, and at least two pixels that reside along the first diagonal line, and wherein the fourth value comprises a second order derivative of pixel values of at least two pixels that reside along the fifth diagonal line, at least two pixels that reside along the sixth diagonal line, and at least two pixels that reside along the second diagonal line.

16. The apparatus of claim 14,
wherein, when the first value and the second value are less than the threshold value, the processing unit is operable to determine a lesser value between the third value and the fourth value,
wherein, when the third value is determined to be less than the fourth value, the processing unit is operable to perform the second type of interpolation based on pixel values of the pixels that reside along the first diagonal line and immediately neighbor the interpolated center pixel to determine the pixel values for the interpolated center pixel, and
wherein, when the fourth value is determined to be less than the third value, the processing unit is operable to perform the second type of interpolation based on pixel values of the pixels that reside along the second diagonal line and immediately neighbor the interpolated center pixel to determine the pixel values for the interpolated center pixel.

17. The apparatus of claim 16, wherein the second type of interpolation comprises a weighted interpolation, and wherein the processing unit is operable to determine values for weights of the weighted interpolation based at least on one of the pixel values of the pixels that reside along the third and fourth diagonal lines and the pixel values of the pixels that reside along the first diagonal line, and the pixel values of the pixels that reside along the fifth and sixth diagonal lines and the pixel values of the pixels that reside along the second diagonal line.

18. The apparatus of claim 10, wherein the processing unit is operable to perform interpolation based on the pixel values for the interpolated center pixel to determine pixel values for other non-center interpolated pixels.

19. The apparatus of claim 10, wherein the processing unit comprises a display processor.

20. A computer-readable storage medium comprising instructions that cause one or more processing units to:
determine a first value based on pixel values of pixels that neighbor an interpolated center pixel of a display and that reside along a first diagonal line, wherein both x- and y-coordinates for the pixels that reside along the first diagonal line are different from one another;
determine a second value based on pixel values of pixels that neighbor the interpolated center pixel of the display that reside along a second line that is orthogonal to the first line, wherein both x- and y-coordinates for the pixels that reside along the second line are different from one another;
compare the first value and the second value to a threshold value; and
when at least one of the first value and the second value is greater than the threshold value, perform an interpolation based at least on one of pixel values of the pixels that reside along the first diagonal line and pixel values of the pixels that reside along the second diagonal line to interpolate a pixel value for the interpolated center pixel of the display.

21. The computer-readable storage medium of claim 20, wherein the first value comprises a first order derivative of pixel values of at least two pixels that reside along the first diagonal line, wherein the first order derivative of the pixel values of the at least two pixels that reside along the first diagonal line comprises a subtraction between a pixel value of a first one of the at least two pixels and a pixel value of a second one of the at least two pixels that each reside along the first diagonal line, wherein the second value comprises a first order derivative of pixel values of at least two pixels that reside along the second diagonal line, and wherein the first order derivative of pixel values of the at least two pixels that reside along the second diagonal line comprises a subtraction between a pixel value of a first one of the at least two pixels and a pixel value of a second one of the at least two pixels that each reside along the second diagonal line.

22. The computer-readable storage medium of claim 20, further comprising instructions to:
when at least one of the first value and the second value is greater than the threshold value, determine a lesser value between the first value and the second value,
wherein, when the first value is determined to be less than the second value, the instructions to perform the interpolation comprise instructions to perform the interpolation based on pixel values of the pixels that reside along the first line and immediately neighbor the interpolated center pixel to determine the pixel value for the interpolated center pixel; and
wherein, when the second value is determined to be less than the first value, the instructions to perform the interpolation comprise instructions to perform the interpolation based on pixel values of the pixels that reside along the second line and immediately neighbor the interpolated center pixel to determine the pixel value for the interpolated center pixel.

23. The computer-readable storage medium of claim 20, wherein the instructions to perform the interpolation comprise instructions to perform a linear interpolation.

24. The computer-readable storage medium of claim 20, wherein the instructions to perform the interpolation comprise instructions to perform a first type of interpolation, the instructions further comprising instructions to:
determine a third value based on pixel values of pixels that neighbor the interpolated center pixel and that reside along a third diagonal line that is parallel to the first diagonal line, and pixel values of pixels that neighbor the interpolated center pixel and that reside along a fourth diagonal line that is parallel to the first diagonal line and the third diagonal line, wherein both x- and y-coordinates for the pixels that reside along the third diagonal line are different from one another, and wherein both x- and y-coordinates for the pixels that reside along the fourth diagonal line are different from one another;
determine a fourth value based on pixel values of pixels that neighbor the interpolated center pixel and that reside along a fifth diagonal line that is parallel to the second diagonal line, and pixel values of pixels that neighbor the interpolated center pixel and that reside along a sixth diagonal line that is parallel to the second diagonal line and the fifth diagonal line, wherein both x- and y-coordinates for the pixels that reside along the fifth diagonal line are different from one another, and wherein both x- and y-coordinates for the pixels that reside along the sixth diagonal line are different from one another; and
when the first value and the second value are less than the threshold value, perform a second type of interpolation based at least on one of pixel values of the pixels that reside along the third and fourth diagonal lines and pixel values of the pixels that reside along the first diagonal line, and pixel values of the pixels that reside along the fifth and sixth diagonal lines and pixel values of the pixels that reside along the second diagonal line to determine the pixel values for the interpolated center pixel.

25. The computer-readable storage medium of claim 24, wherein the third value comprises a second order derivative of pixel values of at least two pixels that reside along the third diagonal line, at least two pixels that reside alone the fourth diagonal line, and at least two pixels that reside along the first diagonal line, and wherein the fourth value comprises a second order derivative of pixel values of at least two pixels that reside along the fifth diagonal line, at least two pixels that reside along the sixth diagonal line, and at least two pixels that reside along the second diagonal line.

26. The computer-readable storage medium of claim 24, further comprising instructions to:
when the first value and the second value are less than the threshold value, determine a lesser value between the third value and the fourth value,
wherein, when the third value is determined to be less than the fourth value, the instructions to perform the second type of interpolation comprise instructions to perform the second type of interpolation based on pixel values of the pixels that reside along the first diagonal line and immediately neighbor the interpolated center pixel to determine the pixel values for the interpolated center pixel, and
wherein, when the fourth value is determined to be less than the third value, the instructions to perform the second type of interpolation comprise instructions to perform the second type of interpolation based on pixel values of the pixels that reside along the second diagonal line and immediately neighbor the interpolated center pixel to determine the pixel values for the interpolated center pixel.

27. The computer-readable storage medium of claim 26, wherein the second type of interpolation comprises a weighted interpolation, and wherein values for weights of the weighted interpolation are based at least on one of the pixel values of the pixels that reside along the third and fourth diagonal lines and the pixel values of the pixels that reside along the first diagonal line, and the pixel values of the pixels that reside along the fifth and sixth diagonal lines and the pixel values of the pixels that reside along the second diagonal line.

28. The computer-readable storage medium of claim 20, further comprising instructions to perform interpolation based on the pixel values for the interpolated center pixel to determine pixel values for other non-center interpolated pixels.

29. An apparatus comprising:
means for determining a first value based on pixel values of pixels that neighbor an interpolated center pixel of a display and that reside along a first diagonal line, wherein both x- and y-coordinates for the pixels that reside along the first diagonal line are different from one another;
means for determining a second value based on pixel values of pixels that neighbor the interpolated center pixel of the display that reside along a second line that is orthogonal to the first line, wherein both x- and y-coordinates for the pixels that reside along the second line are different from one another;
means for comparing the first value and the second value to a threshold value; and
when at least one of the first value and the second value is greater than the threshold value, means for performing an interpolation based at least on one of pixel values of the pixels that reside along the first diagonal line and pixel values of the pixels that reside along the second diagonal line to interpolate a pixel value for the interpolated center pixel of the display.

30. The apparatus of claim 29, wherein the first value comprises a first order derivative of pixel values of at least two pixels that reside along the first diagonal line, wherein the first order derivative of the pixel values of the at least two pixels that reside along the first diagonal line comprises a subtraction between a pixel value of a first one of the at least two pixels and a pixel value of a second one of the at least two pixels that each reside along the first diagonal line, wherein the second value comprises a first order derivative of pixel values of at least two pixels that reside along the second diagonal line, and wherein the first order derivative of pixel values of the at least two pixels that reside along the second diagonal line comprises a subtraction between a pixel value of a first one of the at least two pixels and a pixel value of a second one of the at least two pixels that each reside along the second diagonal line.

31. The apparatus of claim 29, further comprising:
when at least one of the first value and the second value is greater than the threshold value, means for determining a lesser value between the first value and the second value,
wherein, when the first value is determined to be less than the second value, the means for performing the interpolation comprises means for performing the interpolation based on pixel values of the pixels that reside along the first line and immediately neighbor the interpolated center pixel to determine the pixel value for the interpolated center pixel; and
wherein, when the second value is determined to be less than the first value, the means for performing the interpolation comprises means for performing the interpolation based on pixel values of the pixels that reside along the second line and immediately neighbor the interpolated center pixel to determine the pixel value for the interpolated center pixel.

32. The apparatus of claim 29, wherein the means for performing the interpolation comprises means for performing a linear interpolation.

33. The apparatus of claim 29 wherein the means for performing the interpolation comprises means for performing a first type of interpolation, the apparatus further comprising:
means for determining a third value based on pixel values of pixels that neighbor the interpolated center pixel and that reside along a third diagonal line that is parallel to the first diagonal line, and pixel values of pixels that neighbor the interpolated center pixel and that reside along a fourth diagonal line that is parallel to the first diagonal line and the third diagonal line, wherein both x- and y-coordinates for the pixels that reside along the third diagonal line are different from one another, and wherein both x- and y-coordinates for the pixels that reside along the fourth diagonal line are different from one another;
means for determining a fourth value based on pixel values of pixels that neighbor the interpolated center pixel and that reside along a fifth diagonal line that is parallel to the second diagonal line, and pixel values of pixels that neighbor the interpolated center pixel and that reside along a sixth diagonal line that is parallel to the second diagonal line and the fifth diagonal line, wherein both x- and y-coordinates for the pixels that reside along the fifth diagonal line are different from one another, and wherein both x- and y-coordinates for the pixels that reside along the sixth diagonal line are different from one another; and
when the first value and the second value are less than the threshold value, means for performing a second type of interpolation based at least on one of pixel values of the pixels that reside along the third and fourth diagonal lines and pixel values of the pixels that reside along the first diagonal line, and pixel values of the pixels that reside along the fifth and sixth diagonal lines and pixel values of the pixels that reside along the second diagonal line to determine the pixel values for the interpolated center pixel.

34. The apparatus of claim 33, wherein the third value comprises a second order derivative of pixel values of at least two pixels that reside along the third diagonal line, at least two pixels that reside alone the fourth diagonal line, and at least two pixels that reside along the first diagonal line, and wherein the fourth value comprises a second order derivative of pixel values of at least two pixels that reside along the fifth diagonal line, at least two pixels that reside along the sixth diagonal line, and at least two pixels that reside along the second diagonal line.

35. The apparatus of claim 33, further comprising:
when the first value and the second value are less than the threshold value, means for determining a lesser value between the third value and the fourth value,
wherein, when the third value is determined to be less than the fourth value, the means for performing the second type of interpolation comprises means for performing the second type of interpolation based on pixel values of the pixels that reside along the first diagonal line and immediately neighbor the interpolated center pixel to determine the pixel values for the interpolated center pixel, and
wherein, when the fourth value is determined to be less than the third value, the means for performing the second type of interpolation comprises means for performing the second type of interpolation based on pixel values of the pixels that reside along the second diagonal line and immediately neighbor the interpolated center pixel to determine the pixel values for the interpolated center pixel.

36. The apparatus of claim 35, wherein the second type of interpolation comprises a weighted interpolation, and wherein values for weights of the weighted interpolation are based at least on one of the pixel values of the pixels that reside along the third and fourth diagonal lines and the pixel values of the pixels that reside along the first diagonal line, and the pixel values of the pixels that reside along the fifth and sixth diagonal lines and the pixel values of the pixels that reside along the second diagonal line.

37. The apparatus of claim 29, further comprising:
means for performing interpolation based on the pixel values for the interpolated center pixel to determine pixel values for other non-center interpolated pixels.
